(19) United States
(12) Patent Application Publication
(10) Pub. No.: US 2019/0045174 A1
(43) Pub. Date: Feb. 7, 2019

(54) EXTENDED DEPTH OF FOCUS INTEGRAL DISPLAYS

(71) Applicant: Intel Corporation, Santa Clara, CA (US)

(72) Inventors: Ginni Grover, Santa Clara, CA (US); Oscar Nestares, San Jose, CA (US)

(21) Appl. No.: 15/940,190

(22) Filed: Mar. 29, 2018

(51) Int. Cl. H04N 13/302

(52) U.S. Cl. CPC H04N 13/302

(57) ABSTRACT

Extended depth of focus integral displays are disclosed. An example integral display includes a display screen to display an image including a plurality of interlaced elemental images that represent different views of a three-dimensional (3D) image, and an array of lenses proximate the display to integrate the elemental images to form the 3D image, the lenses selectively switchable between a first focal length and a second focal length to increase a depth of focus of the 3D image. Another example integral display includes a display screen to display an image including a plurality of interlaced elemental images that represent different views of a 3D image, and an array of lenses proximate the display to integrate the elemental images to form the 3D image, the array of lenses including first lenses having a first focal length interlaced with second lenses having a second focal length.

### FIELD OF THE DISCLOSURE

This disclosure relates generally to integral displays, and, more particularly, to extended depth of focus (DOF) integral displays.

### BACKGROUND

Integral displays are forms of 3D displays that provide multiple views that trigger the perception of a 3D image by providing multiple depth cues for human eyes such as, but not limited to, convergence and/or accommodation cues. Integral displays provide both horizontal and vertical parallax cues, thus differentiating them from autostereoscopic or multi-view displays. Integral displays allow multiple users to simultaneously view the same 3D scene from their own view points. It is not necessary to wear an accessory, for example, special glasses to view the 3D images displayed by an integral display. Tracking of the head or the eyes is also not required to view these displays.

### BRIEF DESCRIPTION OF THE DRAWINGS

FIG. 1 illustrates an example extended-DOF integral display constructed in accordance with teachings of this disclosure.

FIG. 2 is a top view of the example extended-DOF integral display of FIG. 1.

FIGS. 3A, 3B and 3C are front views of example lenslet arrays that can be used to implement the example extended-DOF integral display of FIGS. 1 and 2.

FIG. 4 is a perspective view of the example lenslet array of FIG. 3A.

FIG. 5 is a side view of an example extended-DOF integral display implemented with the example lenslet array of FIGS. 3A-C and 4.

FIG. 6 is a side view of another example lenslet array that can be used to implement the example extended-DOF integral display of FIGS. 1 and 2.

FIG. 7 is a side view of an example extended-DOF integral display implemented with the example lenslet array of FIG. 6.

FIG. 8 is a flowchart representative of example hardware logic or machine-readable instructions for implementing the example extended-DOF integral display of FIGS. 6 and 7.

FIG. 9 illustrates an example processor platform structured to execute the example machine-readable instructions of FIG. 8 to implement the example extended-DOF integral displays of FIGS. 1, 5 and 7.

In general, the same reference numbers will be used throughout the drawing(s) and accompanying written description to refer to the same or like parts. The figures are not to scale. Instead, for clarity, some dimensions are enlarged in the drawings. Connecting lines or connectors shown in the various figures presented are intended to represent example functional relationships and/or physical or logical couplings between the various elements.

### DETAILED DESCRIPTION

Despite the many advantages of integral displays, conventional integral displays have limited image resolutions, limited DOFs, and limited viewing zones that require tradeoffs in integral display design. For example, to increase DOF, image resolution decreases, and vice versa. With currently feasible display resolutions and pixel densities, only low DOF and low image resolution conventional integral displays are feasible, which do not provide the accommodation cue for full 3D perception. In the case of integral displays, DOF is equivalent to depth of field.

Extended-DOF integral displays are disclosed herein that overcome at least these inherent limitations of conventional integral displays. In examples disclosed herein the DOF can be increased (e.g., extended) by at least a factor of two without decreasing image resolution. In some examples, images are spatially multiplexed using a lenslet array having different focal length lenses. Additionally, and/or alternatively, images are temporally multiplexed using a lenslet array having switchable focal length lenses.

Reference will now be made in detail to non-limiting examples, some of which are illustrated in the accompanying drawings.

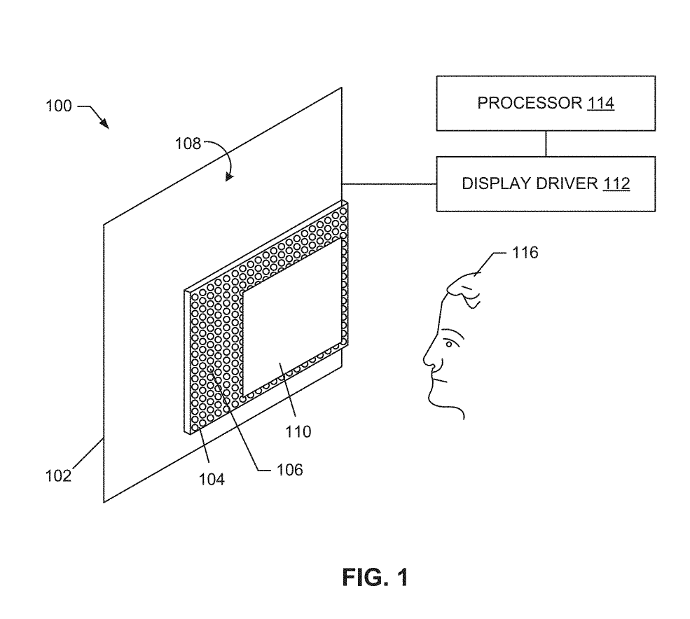

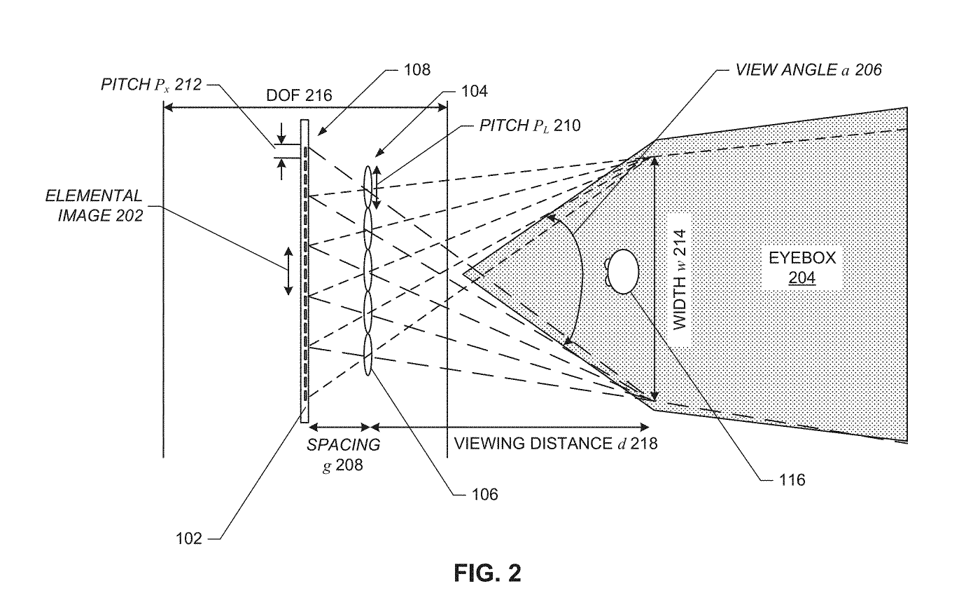

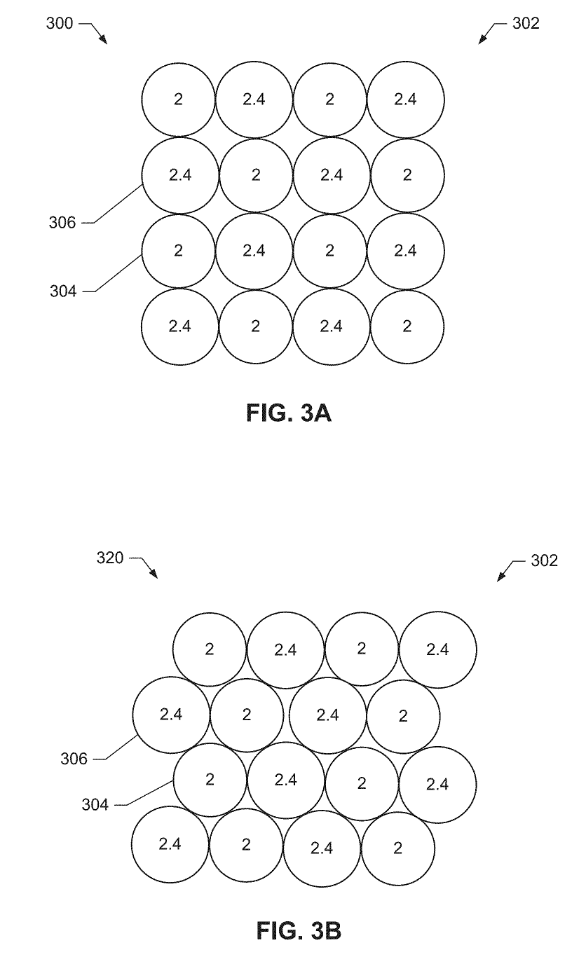

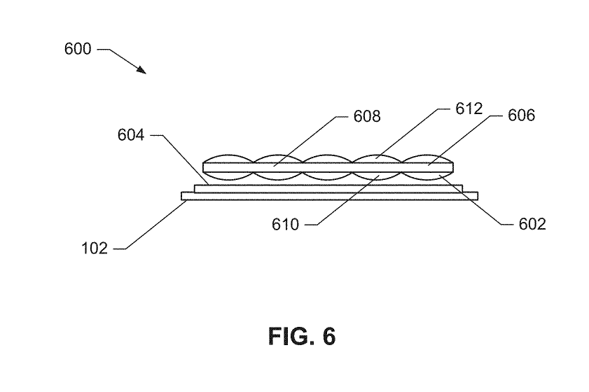

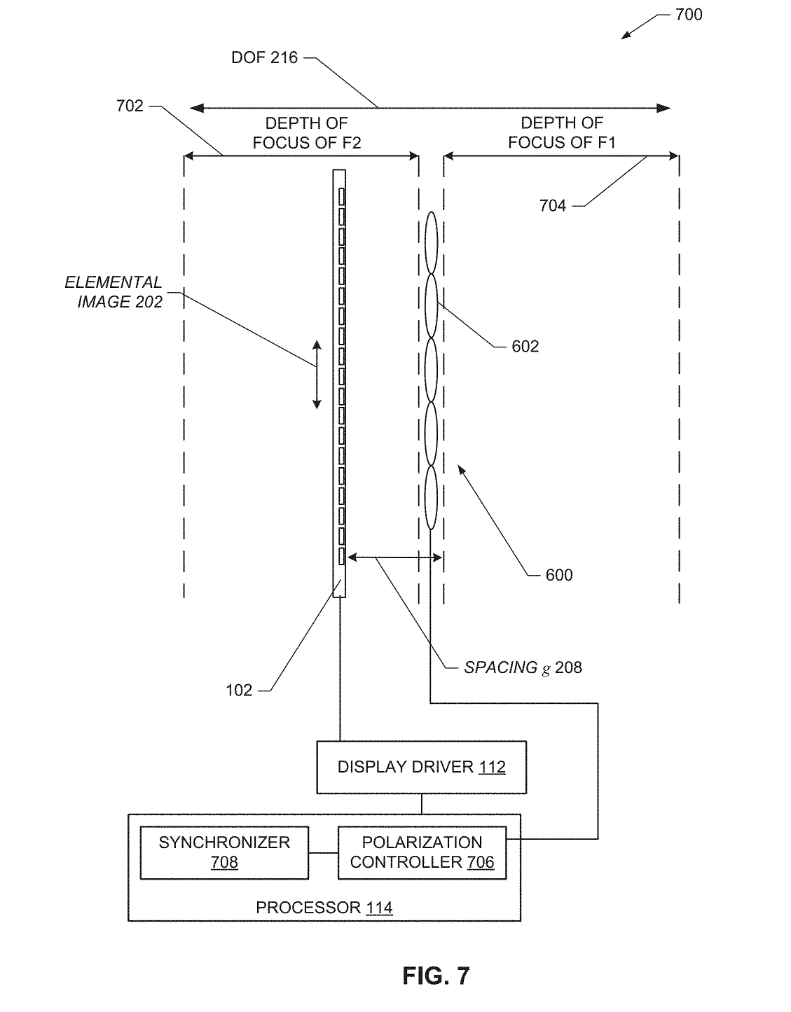

FIG. 1 illustrates an example extended-DOF integral display 100 in accordance with teachings of this disclosure. FIG. 2 is a top view of the example extended-DOF integral display 100 of FIG. 1. The example extended-DOF integral display 100 of FIGS. 1 and 2 includes an example display screen 102 and an example lenslet array 104 in the front of the display screen 102. The lenslet array 104 includes an array of example lenses, one of which is designated at reference numeral 106. The example lenslet array 104 can be implemented to have different focal lengths at the same time, or different focal lengths at different times. The example lenslet arrays 300 and 600 discussed below in connection with FIGS. 3A-C and 4-7 may be used to implement the example lenslet array 104 of the example extended-DOF integral display 100. In the example of FIGS. 3A-C, 4, and-5, the lenslet array 500 has lenses of different focal lengths. In the example of FIGS. 6 and 7, the lenses of the lenslet array 600 are switchable between two or more focal lengths. Using the example lenslet array 300 and/or the example lenslet array 600, the DOF of the example extended-DOF integral display 100 can be increased, without decreasing the spatial resolution of generated 3D images.

An example image 108 displayed on the example display screen 102 includes a plurality of example interlaced elemental images (one of which is designated at reference numeral 202), which represent different views of an example 3D image 110. The example display screen 102 may be, for example, a light emitting diode (LED) display, an organic light emitting diode (OLED) display, a liquid crystal display (LCD) display, a cathode ray tube (CRT) display, an in-place switching (IPS) display, a touchscreen, etc.

To display the image 108 on the display screen 102, the example integral display 100 of FIG. 1 includes an example display driver 112, and an example processor 114. The example display driver 112 of FIG. 1 provides an interface between the example processor 114 and the display screen 102. The example display driver 112 accepts commands and/or data from the processor 114, and generates signals suitable to make the display screen 102 show desired text, image(s), etc. In the illustrated examples of FIG. 7, the processor 114 also controls the switching of the focal lengths of the lenses of a lenslet array.

The example processor 114 of FIG. 1 obtains, generates, etc. desired text, image(s), etc. to be shown on the display screen 102. For example, the desired text, image(s), etc. may be generated using hardware, software, firmware, etc. Additionally, and/or, alternatively, the desired text, image(s), etc. can be obtained from a non-transitory computer-readable storage medium and/or disk. The example processor 114 is hardware. For example, the processor 114 can be implemented by one or more integrated circuits, logic circuits, microprocessors, graphic processing units (GPUs), digital signal processors (DSPs), or controllers from any desired family or manufacturer. The hardware processor 114 may be a semiconductor based (e.g., silicon based) device.

In operation, the example display screen 102 outputs (e.g., presents, displays, etc.) the image 108 composed of the interlaced elemental images 202. The lenslet array 104 integrates those elemental images 202 into the single 3D image 110 to provide different views and/or parallaxes within an eyebox 204 (FIG. 2) (e.g., within a viewing zone, view angle 206, etc.) where a person 116 can view the 3D image 110. This allows the integral display 100 to recreate a sampled light field that can be perceived as a 3D image by the person 116, with objects perceived to be in front and/or behind the integral display 100. Depending on the density of the views generated by the integral display 100, the person 116 can experience parallax and/or retinal blur, making a more robust 3D display, similar to viewing 3D in real world. The example extended-DOF integral display 100 differs from stereoscopic displays, as the integral display 100 does not require glasses and works for multiple viewers simultaneously.

The characteristics of the integral display 100 are defined, at least in part, by parameters of the display screen 102 and the lenslet array 104. In conventional integral displays, the distance g 208 between the lenslet array 104 and the display screen 102 is selected to be the focal length f of the lenses 106 of the lenslet array 104. In this case, the DOF 216 is the product of the number of pixels in each elemental image 202 (roughly area under each lens 106), and the focal length f of the lenses 106. When the distance g 208 is not equal to the focal length f, the spatial resolution R_{I} of the 3D image, the DOF 216 of the integral display 100, and a location l of the central depth plane (e.g., the plane to which the 3D image 110 is projected and centered) from the lenslet array 104 can be expressed mathematically, in the geometrical optics regime, as:

$$\begin{matrix}{R}_{I} = \frac{1}{{P}_{I}} = \frac{g}{{lP}_{X}} & EQN ( 1 ) \\ DOF = \frac{2 {l}^{2} {P}_{X}}{{gP}_{L}} & EQN ( 2 ) \\ l = \frac{gf}{g - f} & EQN ( 3 )\end{matrix}$$

where R_{I} is the effective spatial resolution of the 3D image 110, P_{L} is the pitch 210 of the lenslet array 104 (e.g., diameter of the lenses 106), and Pₓ is the pixel pitch 212 of the display screen 102.

The example eyebox 204 of FIG. 2 defines a lateral range 214 (e.g., width w 214 of the eyebox 204) parallel to the display screen 102, in which the person 116 can move while observing clear 3D images. If the person 116 moves outside the eyebox 204, views of the 3D image 110 repeat and there is aliasing at the border of the eyebox 204. Thus, for comfortable viewing, both eyes of the person 116 should be located within the eyebox 204. The width w 214 of the eyebox 204 at a viewing distance d 218 is given by the following mathematical expressions:

$$\begin{matrix}w = \frac{{nP}_{X} {P}_{L}}{{nP}_{X} - {P}_{L}} & EQN ( 4 ) \\ d = \frac{{gP}_{L}}{{nP}_{X} - {P}_{L}} & EQN ( 5 )\end{matrix}$$

In conventional integral displays there is an inherent tradeoff between spatial resolution R_{L} of the 3D image 110, DOF 216, and the viewing angle a 206. Improvements to one characteristic, reduces the other(s), which can be mathematically expressed as:

$${R}_{L}^{2} * DOF * tan ( \frac{a}{2} ) = S \qquad EQN ( 6 )$$

where S is the resolution of the display screen 102. This implies that, in conventional integral displays, an increase in the DOF 216 can only be achieved when spatial resolution R_{L} decreases. An example conventional integral display with a screen resolution of 0.0315 mm and a lens pitch of 0.3145 mm results in a 3D image resolution of 77 pixels per inch (ppi), but only a DOF 216 of 42 millimeters (mm). For another example conventional integral display, a 0.4448 mm lens pitch results in an image resolution of 57 ppi and a DOF 216 of 68 mm.

While an example manner of implementing the example extended-DOF integral display 100 is illustrated in FIGS. 1 and 2, one or more of the elements, processes and/or devices illustrated in FIGS. 1 and 2 may be combined, divided, re-arranged, omitted, eliminated and/or implemented in any other way. Further, the example display screen 102, the example lenslet array 104, the example display driver 112, the example processor 114 and/or, more generally, the example extended-DOF integral display 100 of FIGS. 1 and 2 may be implemented by hardware, software, firmware and/or any combination of hardware, software and/or firmware. Thus, for example, any of the example display screen 102, the example lenslet array 104, the example display driver 112, the example processor 114 and/or, more generally, the example extended-DOF integral display 100 could be implemented by one or more analog or digital circuit(s), logic circuits, programmable processor(s), programmable controller(s), GPU(s), DSP(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example display screen 102, the example lenslet array 104, the example display driver 112, the example processor 114, and the example extended-DOF integral display 100 is/are hereby expressly defined to include a non-transitory computer-readable storage device or storage disk such as a memory, a digital versatile disk (DVD), a compact disc (CD), a Blu-ray disk, etc. including the software and/or firmware. Further still, the example extended-DOF integral display 100 may include one or more elements, processes and/or devices in addition to, or instead of, those illustrated in FIGS. 1 and 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

It has been advantageously discovered that implementing the example extended-DOF integral display 100 with a lenslet array with an array of lenses of different focal length lenses can increase the DOF 216 by, for example, a factor of two, without decreasing the spatial resolution R_{L} of the 3D image 110.

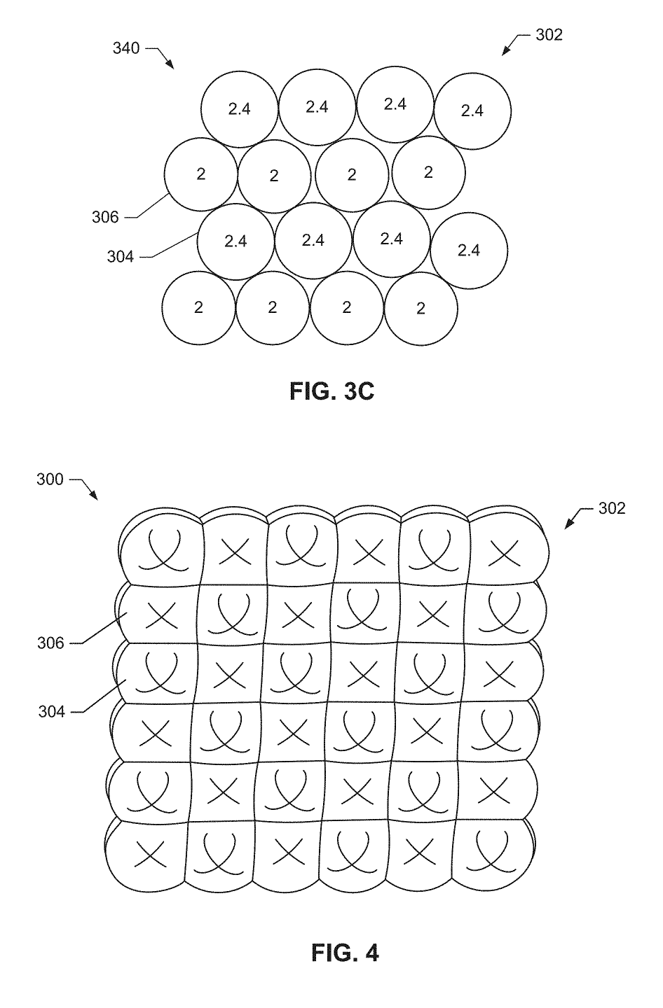

FIG. 3A is a front view of an example lenslet array 300 that can be used to implement the example extended-depth lenslet array 104 of FIGS. 1 and 2. Using the example lenslet array 300 to implement the example integral display 100 increases DOF by, for example, a factor of two, without decreasing the spatial resolution R_{L} of the 3D image 110. FIG. 4 is a perspective view of the example lenslet array 300 of FIG. 3A.

The example lenslet array 300 of FIGS. 3A and 4 includes a rectangularly arranged array of lenses 302 having two different focal lengths (e.g., 2 millimeters (mm) and 2.42 mm). As shown, a set of lenses 304 having a focal length of 2 mm are alternated with a set of lenses 306 having a focal length of 2.42 mm. Other focal lengths, and/or, other numbers of focal lengths (e.g., more than 2) may be used. In the example of FIG. 4, the example lenses 304 and 306 are square rather than circular, with a fill factor of greater than 95%.

FIGS. 3B and 3C are front views of example lenslet arrays 320 and 340 that can be used to implement the example extended-depth lenslet array 104 of FIGS. 1 and 2. In the examples of FIGS. 3B and 3C, the lenses 304 and 306 are hexagonally arranged and/or packed.

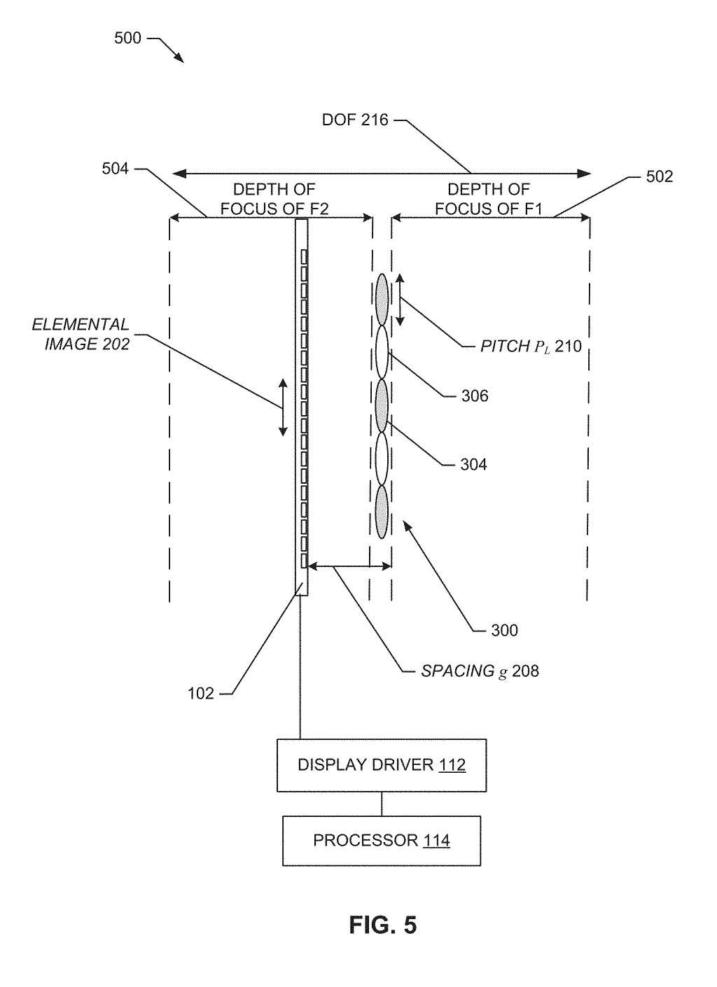

FIG. 5 is a side view of an example extended-DOF integral display 500 formed by implementing the example extended-DOF integral display 100 with the example lenslet array 300 of FIGS. 3A-C and 4. When, as shown in FIG. 5, the display screen 102 is properly spaced from the example lenslet array 300 in the integral display 500, the set of lenses 304 creates integral images behind the display screen 102 with a first DOF 502, and the set of lenses 306 creates integral images in front of the display screen 102 with a second DOF 504, doubling the DOF 216 of the integral display 500. In some examples, the spacing g 208 is determined using the following.

Parameters of the example extended-DOF integral display 500 can be determined by, for example, choosing a pixel size P_{X} 212 for the display screen 102, and choosing an initial lens pitch P_{L} 210 and focal length for the lenses 304 for a desired eyebox 204, viewing distance d 218, and desired 3D image resolution. Calculate image plane location l using, for example, EQN (1) and spacing g 208 using, for example, EQN (3) In some examples, the 3D image resolution for the lenses 306 is selected to be the same as the 3D image resolution for the lenses 304, the DOFs 308 and 310 are selected to be adjacent, the spacings g 208 for the lenses 304 and 306 are selected to be the same. Hence, the 3D image pixel size is constant. Because g 208, P_{X} 212, and the 3D image resolution are the same for the lenses 304 and 306, the image plane location l is same. However, l has a different sign for the lenses 304 compared to the lenses 306. In some examples, lenses 304 and 306 have the same lens pitch P_{L} 210. The focal length of the lenses 306 is calculated using EQN (3) with the correct sign for l.

An example extended-DOF integral display 500 for viewing with the naked eye at viewing distance greater than 0.25 meters (m) has the following parameters:
a. A display screen 102 with 806 pixels per inch (ppi) and a pixel pitch Pₓ 212 of 0.0315 mm.
b. A lenslet array 300 with alternating lenses of 2 different focal lengths, individual lens pitches of 0.3145 mm. Focal lengths of 2 mm and 2.42 mm. Lenses 302, 304 arranged so effective lens pitch P_{L} 210 diagonally between lenses of the same focal length is 0.4448 mm (e.g., sqrt(2)*0.3145).
c. Resulting 3D image resolution of 77 ppi (image spot size of 0.33 mm) with a DOF 216 of 96 mm. The DOF 216 is equally distributed in front and behind the display screen 102, as shown in FIG. 5.

While an example manner of implementing the lenslet array 104 of FIGS. 1 and 2 is illustrated in FIGS. 3A-C, 4, and 5, one or more of the elements, processes and/or devices illustrated in FIGS. 3A-C, 4 and 5 may be combined, divided, re-arranged, omitted, eliminated and/or implemented in any other way. Further still, the example lenslet array 104 of FIGS. 1 and 2 may include one or more elements, processes and/or devices in addition to, or instead of, those illustrated in FIGS. 3A-C, 4 and 5, and/or may include more than one of any or all of the illustrated elements, processes and devices.

FIG. 6 is a side view of another example lenslet array 600 that can be used to implement the example extended-DOF integral display 100 of FIGS. 1 and 2. Using the example lenslet array 600 to implement the example integral display 100 increases DOF by, for example, a factor of two, without decreasing the spatial resolution R_{L} of the 3D image 110. FIG. 7 is a side view of an example extended-DOF integral display 700 formed by implementing the example extended-DOF integral display 100 with the example lenslet array 600 of FIG. 6.

In the illustrated example of FIG. 6, lenses 602 of the example lenslet array 600 are selectively switchable between different focal lengths (e.g., two different focal lengths). To switch the focal lengths of the lenses 602, the example lenslet array 600 includes an example switchable polarizer 604 and an example birefringent material 606 sandwiched between two plano-convex lenslet arrays. An example switchable polarizer 604 is a liquid crystal material switchable between transmitted horizontal polarization and transmitted vertical polarization.

The example birefringent material 606 has a refractive index that depends on the polarization and propagation direction of light emitted from the polarization switching material 604. In the example of FIG. 6, the birefringent material 606 is a layer 608 within the lenslet array 600. For example, the birefringent material 606 can be sandwiched between two micro-lens-arrays (MLA) 610 and 612 of the same focal length. The thickness of the layer 608 depends on the birefringence (e.g., how much refractive index changes with polarization) of the birefringent material 606. Example birefringent material 606 includes calcite, liquid crystals, etc. Other example selectively switchable lenslet arrays include diffractive waveplates, liquid crystal lenses, etc.

When the example switchable polarizer 604 is in a first state (e.g., horizontal polarization), the example birefringent material 606 has a first refractive index, and the lenses 602 have a first focal length. When the switchable polarizer 604 is in a second state (e.g., vertical polarization), the birefringent material 606 has a second refractive index, and the lenses 602 have a second focal length.

When, as shown in FIG. 7, the display screen 102 is properly spaced from the example lenslet array 600 in the extended-DOF integral display 700, the lenses 602 create first integral images behind the display screen 102 with a first DOF 702 when the lenses 602 have the first focal length, and create second integral images in front of the display screen 102 with a second DOF 704 when the lenses have the second focal length. Implementing the integral display 100 with the example lenslet array 600, the DOF 103 of the integral display 700 can be doubled. In operation, the focal lengths of the lenses 602 are switched fast enough so the person 116 unconsciously visually fuses the first and second integral images into a single large DOF image without being aware the integral images are changing.

In some examples, the display screen 102 is updated at 120 cycles per second (Hz) and synchronized with focal length switching of the lenses 602. 3D images are changed at a rate of 60 Hz. In general, faster switching improves image quality by reducing potential flicker. Parameters of the example integral display 100 implemented using the example lenslet array 600, such as focal lengths, spacing, etc., can be calculated using, for example, the example mathematical expressions of EQN (1) to EQN (5).

To control the switching of the example polarizer 604, the example integral display 700 includes an example polarization controller 706 and an example synchronizer 708. The example polarization controller 706 controls the example polarizer 604 between, for example, two states (e.g., two polarizations). The example synchronizer 710 of FIG. 7 synchronizes the display of images 108 with the switching of the states of the polarizer 604. For example, the synchronizer 708 changes the image 108 at a first rate (e.g., 60 Hz) and switches the state of the polarizer 604 at a second rate (e.g., 120 Hz).

An example extended-DOF integral display 700 including the example lenslet array 600 for viewing with the naked eye at viewing distance greater than 0.25 meters (m) has the following parameters:
a. A display screen 102 with 806 pixels per inch (ppi) and a pixel pitch Pₓ 212 of 0.0315 mm.
b. Two plano-convex MLAs 610, 162 with focal length of 1.92 mm, lens pitches P_{L} 210 of 0.502 mm, and thicknesses of 0.4741 mm.
c. A calcite birefringent material 606 with a thickness of 1.4186 mm.
d. Resultant image resolution is 72 ppi (image spot size of 0.33 mm) with a DOF 216 of 84 mm. DOF 216 is equally distributed in front and behind the display. The spacing g 208 is not equal to focal length.
e. Resultant display has approximately 16 views in the eyebox 204 of 184 mm at a distance of 500 mm.
f. Compared to conventional integral displays, the example extended-DOF integral display 100 of FIG. 5 increases the DOF 216 by approximately 1.5× for the same image resolution display.

While an example manner of implementing the lenslet array 104 and integral displays 100 of FIGS. 1 and 2 is illustrated in FIGS. 6 and 7, one or more of the elements, processes and/or devices illustrated in FIGS. 6 and 7 may be combined, divided, re-arranged, omitted, eliminated and/or implemented in any other way. Further, the example polarization controller 706 and the example synchronizer 708 may be implemented by hardware, software, firmware and/or any combination of hardware, software and/or firmware. Thus, for example, any of the example polarization controller 706 and the example synchronizer 708 could be implemented by one or more analog or digital circuit(s), logic circuits, programmable processor(s), programmable controller(s), GPU(s), DSP(s), ASIC(s), PLD(s) and/or FPLD(s). When reading any of the apparatus or system claims of this patent to cover a purely software and/or firmware implementation, at least one of the example polarization controller 706 and the example synchronizer 708 is/are hereby expressly defined to include a non-transitory computer-readable storage device or storage disk such as a memory, a DVD, a CD, a Blu-ray disk, etc. including the software and/or firmware. Further still, the example lenslet array 600 and integral display 700 of FIGS. 6 and 7 may include one or more elements, processes and/or devices in addition to, or instead of, those illustrated in FIGS. 6 and 7, and/or may include more than one of any or all of the illustrated elements, processes and devices.

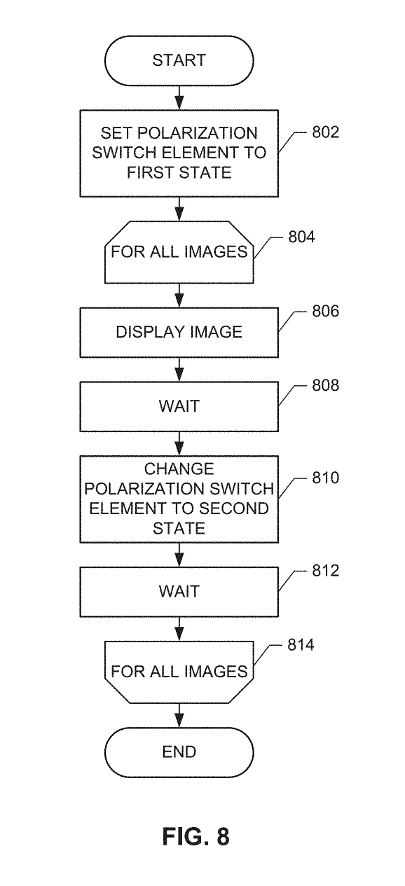

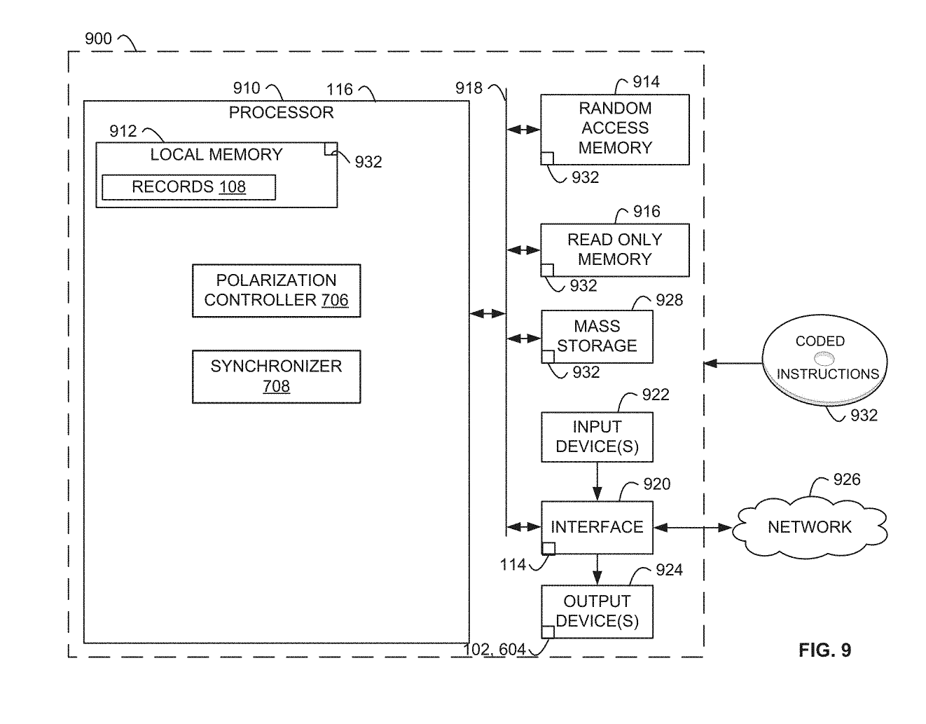

A flowchart representative of example hardware logic or machine-readable instructions for implementing the extended-DOF integral displays 100 and 700 of FIGS. 1, 2 and 7 is shown in FIG. 8. The machine-readable instructions may be a program or portion of a program for execution by a processor such as the processor 910 shown in the example processor platform 900 discussed below in connection with FIG. 9. The program may be embodied in software stored on a non-transitory computer-readable storage medium such as a compact disc read-only memory (CD-ROM), a floppy disk, a hard drive, a DVD, a Blu-ray disk, or a memory associated with the processor 910, but the entire program and/or parts thereof could alternatively be executed by a device other than the processor 910 and/or embodied in firmware or dedicated hardware. Further, although the example program is described with reference to the flowchart illustrated in FIG. 8, many other methods of implementing the example extended-DOF integral display 700 may alternatively be used. For example, the order of execution of the blocks may be changed, and/or some of the blocks described may be changed, eliminated, or combined. Additionally, and/or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 8 may be implemented using executable instructions (e.g., computer and/or machine-readable instructions) stored on a non-transitory computer and/or machine-readable medium such as a hard disk drive, a flash memory, a read-only memory, a CD-ROM, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer-readable medium is expressly defined to include any type of computer-readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

The program of FIG. 8 begins at block 802. The example processor 114 sets the switchable polarizer 604 to a first state (e.g., a first polarization) (block 802). For all images to be displayed (block 804), the processor 114 controls the example display driver 112 to display an image on the display screen 102 (block 806). The processor 114 waits for a period of time having a duration of, for example, 1/120 seconds (block 808), changes the switchable polarizer 604 to a second state (e.g., a second polarization) (block 810), and waits another period of time (e.g., 1/120 seconds) (block 812). When all images have been displayed (block 814), control exits from the example program of FIG. 8.

FIG. 9 is a block diagram of an example processor platform 900 structured to execute the instructions of FIG. 8 to implement the integral displays 100, 500 and 700 of FIGS. 1, 5 and 6. The processor platform 900 can be, for example, a server, a personal computer, a workstation, a self-learning machine (e.g., a neural network), a mobile device (e.g., a cell phone, a smart phone, a tablet such as an IPAD™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 910. The processor 910 of the illustrated example is hardware. For example, the processor 910 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 900 implements the example polarization controller 706 and/or, more generally, the example processor 114.

The processor 910 of the illustrated example includes a local memory 912 (e.g., a cache). The processor 910 of the illustrated example is in communication with a main memory including a volatile memory 914 and a non-volatile memory 916 via a bus 918. The volatile memory 914 may be implemented by Synchronous Dynamic Random-Access Memory (SDRAM), Dynamic Random-Access Memory (DRAM), RAMBUS® Dynamic Random-Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuit 920. The input device(s) 922 permit(s) a user to enter data and/or commands into the processor 910. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. In this example, the output device 924 implements the example display screen 102 and the switchable polarizer 604. The interface circuit 920 of the illustrated example, thus, typically includes a graphics driver card, a graphics driver chip and/or a graphics driver processor. In this example, the interface circuit 920 implements the example display driver 112.

The interface circuit 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 900 of the illustrated example also includes one or more mass storage devices 928 for storing software and/or data. Examples of such mass storage devices 928 include floppy disk drives, hard drive disks, CD drives, Blu-ray disk drives, redundant array of independent disks (RAID) systems, and DVD drives.

Coded instructions 932 including the coded instructions of FIG. 8 may be stored in the mass storage device 928, in the volatile memory 914, in the non-volatile memory 916, and/or on a removable non-transitory computer-readable storage medium such as a CD-ROM or a DVD.

Example extended-DOF integral displays are disclosed herein. Further examples and combinations thereof include at least the following.

Example 1 is an integral display including a display screen to display an image including a plurality of interlaced elemental images that represent different views of a three-dimensional (3D) image; and an array of lenses proximate the display to integrate the elemental images to form the 3D image, the lenses selectively switchable between a first focal length and a second focal length to increase a depth of focus of the 3D image.

Example 2 is the integral display of example 1, further including a switchable polarizer, and a birefringent material in a first of the lenses, a focal length of the first of the lenses responsive to a state of the switchable polarizer.

Example 3 is the integral display of example 2, wherein the switchable polarizer is selectively switchable between a first polarization and a second polarization, and the first of the lenses is to have a first focal length when the switchable polarizer has the first polarization, and a second focal length when the switchable polarizer has the second polarization.

Example 4 is the integral display of any of examples 1 to 3, wherein the 3D image has a first depth of focus when the lenses have the first focal length, and the 3D image has a second depth of focus when the lenses have the second focal length.

Example 5 is the integral display of any of examples 1 to 4, wherein the 3D image is presented at a first location when the lenses have the first focal length, and the 3D image is presented at a second location different than the first location when the lenses have the second focal length.

Example 6 is the integral display of example 5, wherein the first location is perceivable as behind the display, and the second location is perceivable as in front of the display.

Example 7 is the integral display of any of examples 1 to 6, wherein the integral display displays the 3D image during a first period of time with a first depth of focus while the lenses have the first focal length, and displays the 3D image during a second period of time with a second depth of focus while the lenses have the second focal length, durations of the first and second periods of time selected so a person can perceive the 3D image with a third depth of focus greater than the first depth of focus and the second depth of focus.

Example 8 is the integral display of any of examples 1 to 7, further including a display device to control the display screen to display the image, and a processor to control switching of the lenses between the first focal length and the second focal length, and provide the image to the display device.

Example 9 is a method including passing an image through an array of lenses, the image including a plurality of interlaced elemental images that represent different views of a three-dimensional (3D) image, integrating, with the array of lenses, the elemental images to form the 3D image, and switching the lenses between a first focal length and a second focal length while the elemental images are integrated to increase a depth of focus of the 3D image.

Example 10 is the method of example 9, wherein the image is a first image, further including passing a second image through the array of lenses, wherein the focal lengths of the lenses are switched between the first image and the second image passing through the array of lenses.

Example 11 is the method of example 10, further including switching the lenses between the first focal length and the second focal length while elemental images of the second image are integrated with the array of lenses to increase a depth of focus of a second 3D image.

Example 12 is the method of any of examples 9 to 11, wherein the lenses are switched between the first focal length and the second focal length by switching a polarizer between a first polarization and a second polarization.

Example 13 is the method of any of examples 9 to 12, wherein the 3D image has a first depth of focus when the lenses have the first focal length, and the 3D image has a second depth of focus when the lenses have the second focal length, the first depth of focus perceivable as behind a display, the second depth of focus perceivable as in front of the display, the 3D image perceivable by a person as having a third depth of focus greater than the first depth of focus and the second depth of focus.

Example 14 is a non-transitory computer-readable storage medium comprising instructions that, when executed, cause a machine to at least pass an image through an array of lenses, the image including a plurality of interlaced elemental images that represent different views of a three-dimensional (3D) image, integrate, with the array of lenses, the elemental images to form the 3D image, and switch the lenses between a first focal length and a second focal length while the elemental images are integrated to increase a depth of focus of the 3D image.

Example 15 is the non-transitory computer-readable storage medium of example 14, including instructions that, when executed, cause the machine to pass a second image through the array of lenses, wherein the lenses are switched between the image and the second image passing through the array of lenses.

Example 16 is the non-transitory computer-readable storage medium of any of examples 14 to 15, including instructions that, when executed, cause the machine to switch the lenses between the first focal length and the second focal length by switching a polarizer between a first polarization and a second polarization.

Example 17 is the non-transitory computer-readable storage medium of any of examples 14 to 16, wherein the 3D image has a first depth of focus when the lenses have the first focal length, and the 3D image has a second depth of focus when the lenses have the second focal length, the first depth of focus perceivable as behind a display, the second depth of focus perceivable as in front of the display, the 3D image perceivable by a person as having a third depth of focus greater than the first depth of focus and the second depth of focus.

Example 18 is an integral display including a display screen to display an image including a plurality of interlaced elemental images that represent different views of a three-dimensional (3D) image, and an array of lenses proximate the display to integrate the elemental images to form the 3D image, the array of lenses including first lenses having a first focal length interlaced with second lenses having a second focal length.

Example 19 is the integral display of example 18, wherein the first lenses and the second lenses are interlaced according to an alternating pattern.

Example 20 is the integral display of any of examples 18 to 19, wherein the first lenses output the 3D image with a first depth of focus, the second lenses output the 3D with a second depth of focus, the 3D image perceivable by a person with a third depth of focus greater than the first depth of focus and the second depth of focus.

Example 21 is the integral display of any of examples 18 to 20, wherein the first lenses and the second lenses are hexagonally arranged.

Example 22 is the integral display of any of examples 18 to 20, wherein the first lenses and the second lenses are rectangularly arranged.

Example 23 is the integral display of any of examples 18 to 22, wherein the array of lenses further includes third lenses having a third focal length interlaced with the first lenses and the second lenses.

Example 24 is a method including passing an image through an array of lenses, the image including a plurality of interlaced elemental images that represent different views of a three-dimensional (3D) image, the array of lenses including first lenses having a first focal length interlaced with second lenses having a second focal length, integrating, with the first lenses, the elemental images to form a first 3D image with a first depth of focus (DOF) and first perceived location, integrating, with the second lenses, the elemental images to form a second 3D image with a second DOF and second perceived location.

Example 25 is the method of any of example 24, wherein a person perceives the first 3D image and the second 3D image as a third 3D images having a third DOF greater than the first DOF and the second DOF.

Example 26 is the method of any of examples 24 to 25, wherein the first perceived location is in front of a display, and the second perceived location is behind the display.

Example 27 is the method of any of examples 24 to 26, wherein the first lenses and the second lenses are interlaced according to an alternating pattern.

Example 28 is the method of example 27, wherein the first lenses and the second lenses are hexagonally arranged.

Example 29 is the method of example 27, wherein the first lenses and the second lenses are rectangularly arranged.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An integral display, comprising:
a display screen to display an image including a plurality of interlaced elemental images that represent different views of a three-dimensional (3D) image; and
an array of lenses proximate the display to integrate the elemental images to form the 3D image, the lenses selectively switchable between a first focal length and a second focal length to increase a depth of focus of the 3D image.

2. The integral display of claim 1, further including:
a switchable polarizer; and
a birefringent material in a first of the lenses, a focal length of the first of the lenses responsive to a state of the switchable polarizer.

3. The integral display of claim 2, wherein the switchable polarizer is selectively switchable between a first polarization and a second polarization, and the first of the lenses is to have a first focal length when the switchable polarizer has the first polarization, and a second focal length when the switchable polarizer has the second polarization.

4. The integral display of claim 1, wherein the 3D image has a first depth of focus when the lenses have the first focal length, and the 3D image has a second depth of focus when the lenses have the second focal length.

5. The integral display of claim 1, wherein the 3D image is presented at a first location when the lenses have the first focal length, and the 3D image is presented at a second location different than the first location when the lenses have the second focal length.

6. The integral display of claim 5, wherein the first location is perceivable as behind the display, and the second location is perceivable as in front of the display.

7. The integral display of claim 1, wherein the integral display displays the 3D image during a first period of time with a first depth of focus while the lenses have the first focal length, and displays the 3D image during a second period of time with a second depth of focus while the lenses have the second focal length, durations of the first and second periods of time selected so a person can perceive the 3D image with a third depth of focus greater than the first depth of focus and the second depth of focus.

8. The integral display of claim 1, further including:
a display device to control the display screen to display the image; and
a processor to control switching of the lenses between the first focal length and the second focal length, and provide the image to the display device.

9. A method of operating an integral display, comprising:
passing an image through an array of lenses, the image including a plurality of interlaced elemental images that represent different views of a three-dimensional (3D) image;
integrating, with the array of lenses, the elemental images to form the 3D image; and
switching the lenses between a first focal length and a second focal length while the elemental images are integrated to increase a depth of focus of the 3D image.

10. The method of claim 9, wherein the image is a first image, further including passing a second image through the array of lenses, wherein the focal lengths of the lenses are switched between the first image and the second image passing through the array of lenses.

11. The method of claim 10, further including switching the lenses between the first focal length and the second focal length while elemental images of the second image are integrated with the array of lenses to increase a depth of focus of a second 3D image.

12. The method of claim 9, wherein the lenses are switched between the first focal length and the second focal length by switching a polarizer between a first polarization and a second polarization.

13. The method of claim 9, wherein the 3D image has a first depth of focus when the lenses have the first focal length, and the 3D image has a second depth of focus when the lenses have the second focal length, the first depth of focus perceivable as behind a display, the second depth of focus perceivable as in front of the display, the 3D image perceivable by a person as having a third depth of focus greater than the first depth of focus and the second depth of focus.

14. A non-transitory computer-readable storage medium comprising instructions that, when executed, cause a machine to at least:
pass an image through an array of lenses, the image including a plurality of interlaced elemental images that represent different views of a three-dimensional (3D) image;
integrate, with the array of lenses, the elemental images to form the 3D image; and
switch the lenses between a first focal length and a second focal length while the elemental images are integrated to increase a depth of focus of the 3D image.

15. The non-transitory computer-readable storage medium of claim 14, including instructions that, when executed, cause the machine to pass a second image through the array of lenses, wherein the lenses are switched between the image and the second image passing through the array of lenses.

16. The non-transitory computer-readable storage medium of claim 14, including instructions that, when executed, cause the machine to switch the lenses between the first focal length and the second focal length by switching a polarizer between a first polarization and a second polarization.

17. The non-transitory computer-readable storage medium of claim 14, wherein the 3D image has a first depth of focus when the lenses have the first focal length, and the 3D image has a second depth of focus when the lenses have the second focal length, the first depth of focus perceivable as behind a display, the second depth of focus perceivable as in front of the display, the 3D image perceivable by a person as having a third depth of focus greater than the first depth of focus and the second depth of focus.

18-29. (canceled)
